(19) United States
(12) Patent Application Publication
(10) Pub. No.: US 2002/0103922 A1
(43) Pub. Date: Aug. 1, 2002

(54) Wireless information delivery

(75) Inventors: Brian L. Arend, Masonville, CO (US); Alfredo E. Gonzalez, Boulder, CO (US); Charles I. Cook, Louisville, CO (US)

Correspondence Address: QWEST COMMUNICATIONS INTERNATIONAL INC, LAW DEPT INTELLECTUAL PROPERTY GROUP, 1801 CALIFORNIA STREET, SUITE 3800, DENVER, CO, 80202, US

(73) Assignee: Qwest Communications International Inc., Denver, CO (US)

(21) Appl. No.: 09/771,252

(22) Filed: Jan. 26, 2001

(51) Int. Cl. G06F 15/16

(52) U.S. Cl. 709/234; 709/217

(57) ABSTRACT

A wireless network is utilized to deliver non-real-time information to subscribers during periods when the network utilization for real-time information is low. A data delivery server contains information for delivery to wireless receivers/transceivers. An internetworking function element receives the information from the data delivery server and delivers the information at a time determined to reduce the impact of information delivery on the wireless distribution system. This may be at preset times such as during evening or early morning hours or may be at times when measured network loads are low.

### TECHNICAL FIELD

The present invention relates to delivering information to subscribers through a wireless communication system.

### BACKGROUND ART

Wireless communication systems, such as PCS, cellular, “satellite” systems, and the like, allow subscribers to send and receive information from anywhere within the coverage area. Typically, such communication has been real-time voice. Increasingly, textual information such as paging and limited Internet access has also become available. A limiting factor in the ability to delivery large amounts of information to the subscriber is the bandwidth of the wireless communication system. Band limiting may occur in the link between the wireless receiver and a corresponding transmitting access point, may result from routing or switching within the wireless system, or may result from information sources outside of the wireless network.

What is needed is to deliver increasingly larger sets of information to wireless subscribers. In particular, non-real-time information should be transferred to subscribers in a manner which does not significantly degrade the performance of the wireless network.

### DISCLOSURE OF INVENTION

A wireless network is utilized to deliver non-real-time information to subscribers during periods when the network utilization for real-time information is low. This may be at preset times such as during evening or early morning hours or may be at times when measured network loads are low.

A system for delivering information to at least one subscriber is provided. Each subscriber has a data storage element for holding delivered information. A wireless receiver, which may be part of a wireless transceiver, communicates with the data storage element. The data storage element may be part of the receiver/transceiver, may be removable from the receiver/transceiver, or may be in a separate device. A wireless distribution system transmits to each receiver/transceiver. A data delivery server contains information for delivery to the wireless receivers/transceivers. An internetworking function element receives the information from the data delivery server and delivers the information based on a determined delivery event to reduce the impact of information delivery on either or both of the wireless distribution system (and the wireless receiver/transceiver.

In an embodiment of the present invention, radio access points communicate with wireless receivers/transceivers. Distribution elements route information between access points and between an access point and a communication network. The data delivery server may be connected to the communication network. The internetworking function element receives information from the communication network and forwards the information to at least one distribution element based on the delivery event. The communication network may be a wireline network, a wireless network separate from the target wireless receiver/transceiver, the same wireless network servicing the target wireless receiver/transceiver, or any combination. Information may be sourced to the data delivery server from protected computer systems.

In other embodiments of the present invention, the data storage element and the wireless receiver/transceiver are a single unit. The data storage element may also be disposed within a cradle for supplying power to the wireless receiver/transceiver. The data storage element may also be a component in a computer system. The data storage element may also be a removable memory module.

In still another embodiment of the present invention, the internetworking function element or the data delivery server receives instructions about a priority of information for delivery. The information is then delivered based on the instructed priority, time, network characteristics thresholds, and other parameters set by the user or the service provider. The receivers/transceivers may be queried before information is transmitted. Priority preferences and other information delivery characteristics may be maintained in a data delivery profile.

In yet another embodiment of the present invention, the wireless distribution system distributes information simultaneously or broadcasts to a plurality of subscriber wireless receivers/transceivers.

A method for delivering information to a wireless receiver/transceiver is also provided. Information is received for delivery. A time to deliver the information is determined based on reducing the impact of information delivery on the wireless distribution system in communication with the wireless receiver/transceiver. The information is delivered to the wireless distribution system, which wirelessly transmits the information to the receiver/transceiver.

The above objects and other objects, features, and advantages of the present invention are readily apparent from the following detailed description of the best mode for carrying out the invention when taken in connection with the accompanying drawings.

### BRIEF DESCRIPTION OF DRAWINGS

FIG. 1 is a schematic diagram of an information delivery system according to an embodiment of the present invention;

FIG. 2 is a block diagram of a wireless receiver/transceiver and cradle according to an embodiment of the present invention; and

FIG. 3 is a flow diagram illustrating information delivery according to an embodiment of the present invention.

### BEST MODE FOR CARRYING OUT THE INVENTION

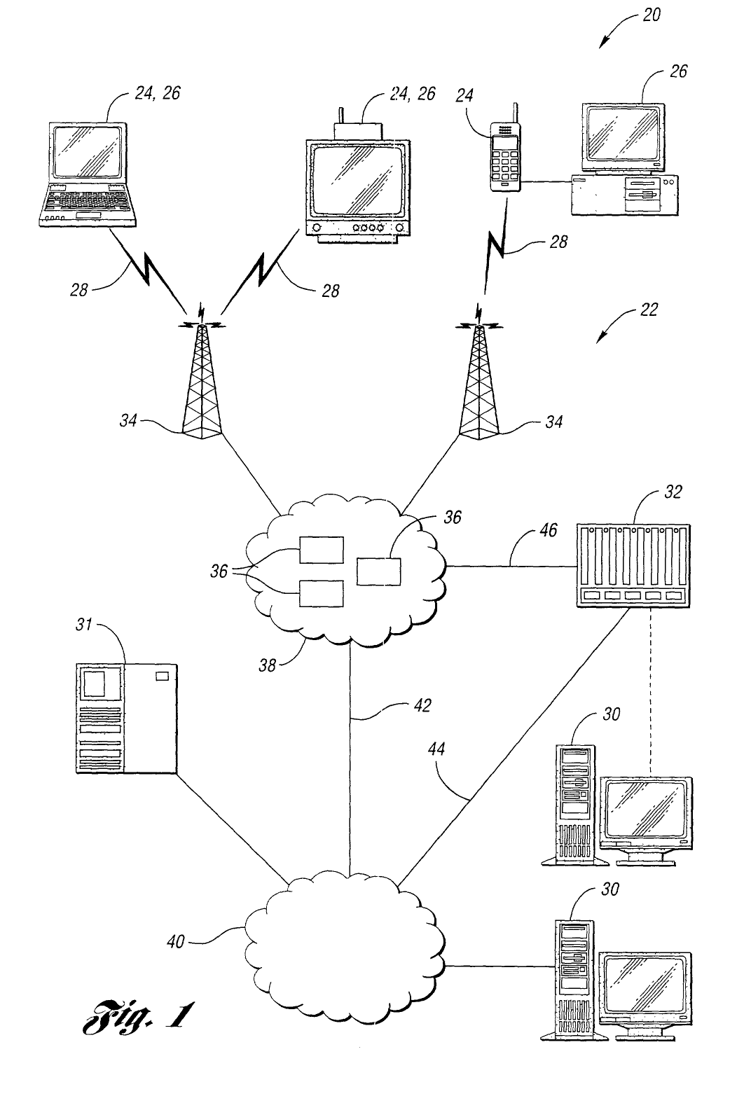

Referring to FIG. 1, a schematic diagram of an information delivering system according to an embodiment of the present invention is shown. An information delivery system, shown generally by 20, includes a wireless distribution system, shown generally by 22. Wireless receivers 24 or transceivers 24 contain or have access to data storage elements 26 for holding received information. Receivers/transceivers 24 are in wireless communication with wireless distribution system 22 through wireless links 28. Data delivery server 30 generates or receives non-real-time information for delivery to one or more wireless receivers 24. Data delivery server may be any type of device capable of accomplishing a data transfer, such as a network server or a personal computer for example. Information may be sent to data delivery server 30 by one or more protected computer systems 31, such as may be supported by organizations including corporate, commercial, financial, governmental, educational, and various other interests. This allows protected system 31 to maintain a firewall against unwanted access while still permitting information to be pushed to users through wireless receivers/transceivers 24. Protected computer system 31 may also function as data delivery server 30.

Internetworking function element 32 in communication with wireless distribution system 22 receives information to be delivered from data delivery server 30. Internetworking function element 32 delivers the information to receivers/transceivers 24 at a delivery time or event based on reducing the impact of information delivery on wireless distribution system 22. Reducing the impact of information delivery includes maintaining desired parameters such as quality of service, bandwidth, delay times, and the like. Internetworking function element 32 may be implemented using any processing platform capable of forwarding the data and, possibly, receiving information on loads in wireless distribution system 22. One such processing platform is an IWF version 4.0 from 3Com Corporation that is programmed and configured to perform internetworking functions.

A large variety of information may be sent to subscribers with wireless receivers/transceivers 24 using this technique. Information types include news, music, entertainment, financial information, weather, classified advertisements, commercial advertisements, sports information, calendars, books, magazines, newspapers, movies, software, software updates, games, and the like. Many information formats are also possible, including textual files such as are commonly used with computers, electronic books, personal digital assistants (PDAs), and the like. Audio, video, and still picture formats may also be used. Specialized data formats such as directories for PDAs and telephones, map information, electronic programming guides, electronic mail, calenders and the like are further possibilities.

Wireless receiver/transceiver 24 may take on a variety of forms, such as a telephone, a PDA, a wireless modem, a computer, an Internet appliance, a television set-top box, and the like. Data storage element 26 may be incorporated into wireless receiver/transceiver 24, may be removable from wireless receiver/transceiver 24, may be separate from wireless receiver/transceiver 24, or any combination.

Wireless distribution system 22 includes radio access points 34 forming wireless links 28 with wireless receivers/transceivers 24 within a coverage area. Radio access point 34 may be a base, transceiver station (BTS) as is known in the art. Radio access points 34 are interconnected by distribution elements 36 such as base station controllers, mobile switching centers, routers, switches, multiplexers, and the like, which together form routing network 38. Routing network 38 may be centrally located or distributed throughout a geographic area.

Routing network 38 also exchanges information with wireline communication network 40 through one or more links 42. Wireline communication network 40 may include one or more of a standard telephone network (PSTN), a long distance telephone system, the Internet, or the like. Typically, data delivery server 30 is connected to wireline communication network 40. Internetworking function element 32 has its own connection 44 to wireline communication network 40 and a separate connection 46 to at least one distribution element 36 in routing network 38.

Information may also be uploaded using basically the reverse process. Transceiver 24 may also operate to transmit lower priority information based on a time or event that reduces the impact of information delivery on wireless distribution system 22. Transceiver 24 may transmit at a particular time, may monitor performance characteristics of system 22 to determine when to transmit, or may receive a signal from radio access point 34, distribution element 36, internetworking function element 32, or similar communication component indicating transmission is appropriate. Information sent from transceiver 24 may include responses or updates to previously received information, such as programming selections for a set-top box, calender or to-do list modifications,, payment authorizations, electronic mail responses, and the like. Information sent from transceiver 24 may also include content to be delivered to another transceiver 24.

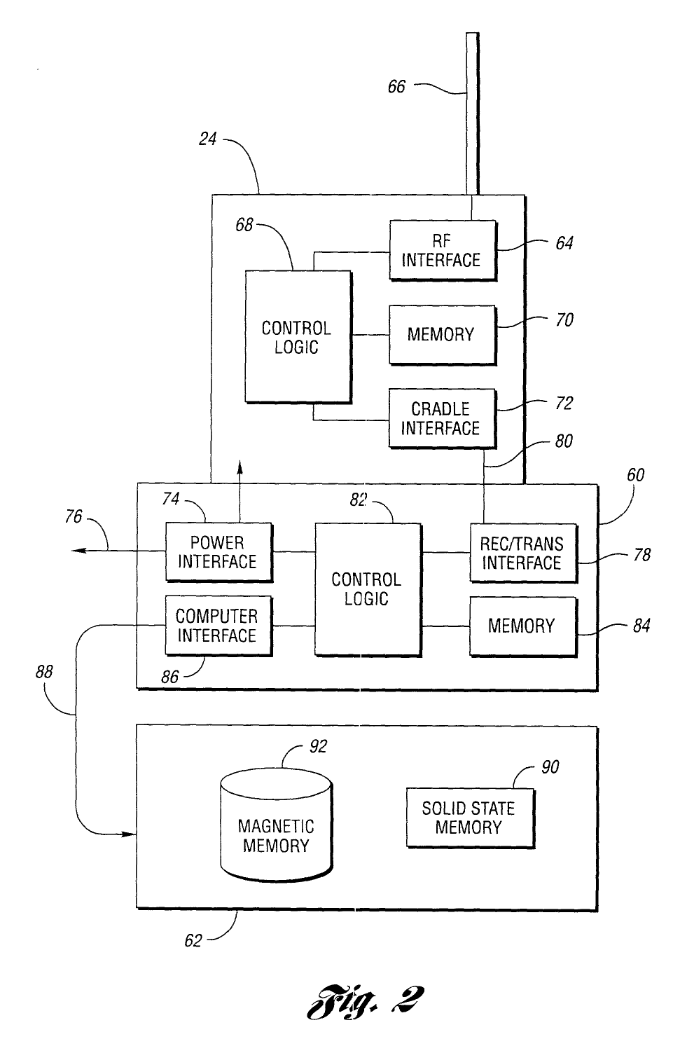

Referring now to FIG. 2, a block diagram of a wireless receiver/transceiver and cradle according to an embodiment of the present invention is shown. Cradle 60 is designed to accept wireless receiver/transceiver 24. The basic design for cradle 60 is similar to that of cradles used to support wireless communication devices such as telephones, computers, PDAs, and the like. Cradle 60 supplies power for charging wireless receiver/transceiver 24 and provides a link between receiver/transceiver 24 and additional equipment such as computer 62. Cradle 60 may or may not contain memory for storing information downloaded by receiver/transceiver 24 or uploaded by transceiver 24.

Wireless receiver/transceiver 24 typically includes radio frequency (RF) interface 64 connected to antenna 66. RF interface 64 demodulates and decodes radio signals received by antenna 66 and modulates and encodes signals sent by antenna 66. If the signals contain information, control logic 68 may store the information on receiver/transceiver memory 70 or, if receiver/transceiver 24 is in cradle 60, may pass the information between cradle interface 72 and cradle 60. Wireless receiver/transceiver 24 may also pass information previously stored in memory 70 into cradle 60 through cradle interface 72.

Cradle 60 includes power interface 74 which receives current through power cord 76 and provides electrical power to cradle 60 and, if docked in cradle 60, to receiver/transceiver 24. Cradle 60 also includes receiver/transceiver interface 78 for receiving information from and transmitting information to cradle interface 72 along cradle link 80. Cradle link 80 may be serial or parallel electrical connections formed when receiver/transceiver 24 is placed into cradle 60. Cradle link 80 may also be formed by an infrared or radio link between cradle interface 72 and receiver/transceiver interface 78. Cradle (control logic 82 routes information from receiver/transceiver interface 78 and may store the information in cradle memory 84. For long-term storage, printing, viewing, and the like, information may be transmitted via computer interface 86 through computer link 88 into computer 62. Link 88 may be any suitable media including RS-232 cable, USB cable, FireWire cable, infrared, radio, or the like. Once transferred into computer 62, the information may be held in any suitable storage media such as solid state memory 90, magnetic memory 92, or the like.

All or a portion of one or more of memory 70, memory 84, and memory 90 may be removable. Removable memory may be implemented as a memory module such as, for example, a MEMORY STICK™ from Sony Corporation. The use of removable memory 70, 84, 90 permits data to be loaded into wireless receiver/transceiver 24 while receiver/transceiver 24 is not connected to any support component, such as cradle 60 or computer 62, then removed for display, printing, or long-term storage.

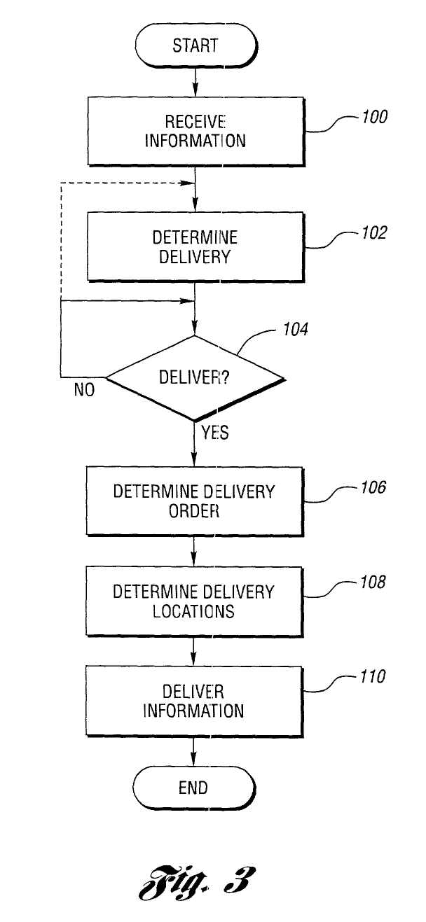

Referring now to FIG. 3, a flow diagram illustrating information delivery according to an embodiment of the present invention is shown. As will be appreciated by one of ordinary skill in the art, the operations illustrated in the flow diagram are not necessarily sequential operations. The order of steps may be modified within the spirit and scope of the present invention and the order shown here is for logical presentation. Also, the method illustrated in FIG. 3 may be implemented by any combination of hardware, software, firmware, and the like at one location or distributed. The present invention transcends any particular implementation and the embodiment is shown in sequential flow chart form for ease of illustration.

Information is received in block 100. Data delivery server 30 forwards information to internetworking function element 32. In one embodiment, this delivery occurs whenever such information becomes available. For example, when a newspaper is released for printing, an electronic version is sent to internetworking function element 32. An advantage of the present invention is the ability to have such information updated electronically even after paper copies have been printed. In another embodiment, data is forwarded from data delivery server 30 to internetworking function element 32 it a time determined to reduce the impact on wireless distribution system 22 of data delivery. Communication between delivery server 30 and internetworking function element 32 may be through a direct connection, through some network that does not significantly impact wireless distribution system 22, or delivery server 30 may be combined with internetworking function element 32.

Information delivery time or bandwidth availability is determined in block 102. In one embodiment of the present invention, information is sent to wireless distribution system 22 triggered by a particular time of day. For example, traffic on wireless distribution system 22 is typically light in the early morning hours. Hence, the bandwidth of wireless distribution system 22, which would otherwise be underutilized, is effectively used to distribute non-real-time information. In another embodiment, wireless distribution system 22 forwards at least one parameter indicating conditions of routing network 38 to internetworking function element 32 or data delivery server 30. For example, parameters indicating load information from a radio management function within one or more distribution elements 36 may be generated. Any parameters that indicate the operating conditions of wireless distribution system 22 may be used, including an indication of traffic load in routing network 38, packet delivery delay times, information throughput rates, equipment utilization rates, routing statistics, and the like. When one or more selected parameters are within a threshold range, internetworking function element 32 begins transmitting information to receivers/transceivers 24. If the threshold range is exceeded, internetworking function element 32 may temporarily suspend or curtail transmission.

Operation of information delivery may also be based on the activity of the destination wireless receiver/transceiver 24. If receiver/transceiver 24 receives a telephone call or other higher priority communication access request, information transmission may be suspended or the transfer rate reduced to accommodate the higher priority communication.

The conditions are likely to vary at different locations, as well as at different times, within wireless distribution system 22. These conditions may be taken into account when determining if and when information delivery should begin. For example, the location of wireless receiver/transceiver 24 within wireless distribution system 22 may be determined by accessing a mobile switching center. Once this location is known, characteristics of relevant portions of wireless distribution system 22 may be obtained from a base station controllers in communication with the wireless receiver/transceiver 24. Depending on the construction of wireless distribution system 22, information from multiple base station controllers may be used to determine how and when to route information to receiver/transceiver 24.

A check is made in block 104 to determine if delivery should begin. If a specific time is used to trigger information delivery, block 104 represents waiting until the specified time. If the delivery time is based on some measure of wireless distribution system 22, block 104 represents waiting for one or more appropriate conditions or triggering events. If the conditions or events within wireless distribution system cease to be appropriate, transmission may be suspended or curtailed. A new determination of an information delivery time may be redetermined in block 102.

A determination of delivery order is made in block 106. Subscribers to information delivery system 20 may specify an order for delivering information. For example, software updates may receive a higher priority than e-mail which may, in turn, be given a higher priority than delivery of the daily newspaper. Priorities may be established at the time service is commenced and updated through various means including automated telephone access, call center personnel, or through selections on a web page.

In addition to determining order, a decision about whether or not information should be delivered at all may be made. For example, a user may specify that no file over a certain size may be delivered. Also, a subscriber may specify that up to a total amount of information may be delivered. The subscriber may filter the type of data to be delivered. User profiles may be established to augment how either or both of internetworking function element 32 and data delivery server 30 receive and deliver information content. Priority information, as well as other information delivery characteristics, may be kept in a data delivery profile for each subscriber in internetworking function element 32. Other information delivery characteristics could include preferred delivery times, not-to-deliver times, alternate delivery means and locations, per item and total size restrictions, content restrictions, and the like.

A query of radio receiver/transceiver 24 may be made prior to delivery and information delivery may be based on the query results. The query may return information such as the storage space available on receiver/transceiver 24 or supporting equipment, the type of receiver/transceiver 24, the types and formats of files supported by receiver/transceiver 24, the status of receiver/transceiver 24 and the like. Status queries could include whether or not receiver/transceiver 24 is cradled or not, is in active use by a user or not, is operating on battery power or not, currently logged on user, activation of security or parental controls, and the like.

Delivery locations are determined in block 108. Certain information, such as electronic mail, may be destined for a single subscriber based on the subscriber's address. Other types of information, such as newspapers, magazines, advertisements, and the like may be widely distributed based on subscription or subscriber characteristics. Such information may be simultaneously delivered or broadcast to multiple receivers/transceivers 24.

The information is delivered in block 110. In one embodiment, data is held in data delivery server 30, wireline communication network 40 is a telecommunication system, and wireless receiver/transceiver 24 is a telephone. A call is placed between data delivery server 30 and receiver/transceiver 24 for the subscriber expecting an information transfer. This call is handled by a switch 36 in routing network 38 and is routed through internetworking function element 32, which establishes a data link to telephone receiver/transceiver 24. Receiver/transceiver 24, either by itself, through cradle 60, or through interconnected computer 62, answers the incoming call and establishes an FTP or other communication protocol session with data delivery server 30. Once information delivery is completed, the user may be optionally notified through a variety of means, including telephone ringing, electronic mail, voice mail, SMS messages, visual display, or the like.

In another embodiment of the present invention, information may be delivered to receiver/transceiver 24 over more than one session. Multiple sessions may result from many situations, including a temporary loss of connection between receiver/transceiver 24 and wireless distribution system 22, a temporary increase in the traffic through wireless distribution system 22, an indication that storage in receiver/transceiver 24 is full, and the like. Techniques for transferring data over multiple sessions, such as are used in the z-modem protocol, are well known in the art.

Many variations and additions are possible within the spirit and scope of the present invention. For example, a subscriber could indicate to data delivery server 30 or internetworking function element 32 that information delivery should be suspended; routed to a different wireless receiver/transceiver 24; routed using a different delivery means than wireless distribution system 22, such as the through the Internet, by paper delivery, or by fax; or held for future access. The subscriber may also indicate that copies of information be forwarded to another location, forwarded through another delivery means, or held in storage at data delivery server 30 or internetworking function element 32.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for delivering information to at least one subscriber comprising:
a subscriber data storage element;
a wireless receiver in communication with the data storage element;
a wireless distribution system in wireless communication with each receiver/transceiver;
a data delivery server in communication with the wireless distribution system, the data delivery server containing information to be delivered to at least one wireless receiver; and
an internetworking function element in communication with the wireless distribution system, the internetworking function element operative to receive the information to be delivered and to deliver the information based on a determined delivery event to reduce the impact of information delivery on the wireless distribution system.

2. A system for delivering information as in claim 1 wherein the wireless distribution system comprises:
a plurality of radio access points operative to communicate with a wireless receiver;
a wireline communication network; and
at least one distribution element operative to route information between access points and between an access point and the wireline communication system.

3. A system for delivering information as in claim 2 wherein the data delivery server is connected to the wireline communication system.

4. A system for delivering information as in claim 3 wherein the internetworking function element is connected to the wireline communication system and the at least one distribution element,.

5. A system for delivering information as in claim 1 wherein the data storage element and the wireless receiver are a single unit.

6. A system for delivering information as in claim 1 wherein the data storage element is disposed within a cradle for supplying power to the wireless receiver.

7. A system for delivering information as in claim 1 wherein the data storage element is a component in a computer system.

8. A system for delivering information as in claim 1 wherein the data storage comprises removable memory.

9. A system for delivering information as in claim 1 wherein the delivery event is based on a time of day.

10. A system for delivering information as in claim 1 wherein the delivery event is based on measured parameters in the wireless distribution system.

11. A system for delivering information as in claim 1 wherein at least one of the internetworking function element and the data delivery server is further operative to receive instructions about a priority of information for delivery and to deliver the information based on the priority.

12. A system for delivering information as in claim 1 wherein the wireless distribution system is operative to distribute information simultaneously to a plurality of subscriber wireless receiver.

13. A system for delivering information as in claim 1 wherein the wireless receiver is part of a wireless transceiver.

14. A system for delivering information as in claim 13 wherein the wireless transceiver is operative to transmit information through the wireless distribution system based on a determined delivery event to reduce the impact of information delivery on the wireless distribution system.

15. A system for delivering information as in claim 1 wherein the wireless receiver receives notification once information delivery is complete.

16. A system for delivering information as in claim 1 further comprising at least one protected computer system sourcing information to be delivered to the wireless receiver.

17. A system for delivering information as in claim 1 wherein the internetworking function element queries the wireless receiver prior to delivering information.

18. A method for delivering information to a wireless receiver/transceiver comprising:
receiving information for delivery;
determining a time to deliver the information, the time based on reducing the impact of information delivery on a wireless distribution system in communication with the wireless receiver/transceiver;
delivering the information to the wireless distribution system; and
wirelessly transmitting the information to the receiver/transceiver.

19. A method for delivering information as in claim 18 wherein the information is received over a wireline connection.

20. A method for delivering information as in claim 18 further comprising receiving the transmitted information and storing the received information in a wireless receiver/transceiver.

21. A method for delivering information as in claim 18 further comprising receiving the transmitted information and storing the received information in a cradle supplying power to a wireless receiver/transceiver.

22. A method for delivering information as in claim 18 further comprising receiving the transmitted information and storing the received information in a computer system in communication with the wireless receiver/transceiver.

23. A method for delivering information as in claim 18 further comprising receiving the transmitted information and storing the received information in a removable memory module.

24. A method for delivering information as in claim 18 wherein the determined time to deliver the information is based on a preset time of day.

25. A method for delivering information as in claim 18 wherein the determined time to deliver the information is based on measured loads in the wireless distribution system.

26. A method for delivering information as in claim 18 further comprising receiving instructions about a priority of information for delivery.

27. A method for delivering information as in claim 18 wherein wirelessly transmitting the information comprises simultaneously transmitting to a plurality of wireless receivers/transceivers.

28. A method for delivering information as in claim 18 further comprising establishing a data delivery profile indicating information delivery characteristics.

29. A method for delivering information as in claim 18 further comprising querying the wireless receiver/transceiver prior to delivering the information to the wireless distribution system.

30. A method for delivering information as in claim 18 wherein the information for delivery is received from at least one protected computer system.
